(19) United States
(12) Patent Application Publication
(10) Pub. No.: US 2021/0053386 A1
(43) Pub. Date: Feb. 25, 2021

(54) SUBSEQUENT ALTERING OF A DECORATIVE SURFACE

(71) Applicant: SWISS KRONO Tec AG, Luzern (CH)

(72) Inventors: Pius Steinmann, Schötz (CH); Vito Monteleone, Wolhusen (CH); Stefan Christen, Hergiswil (CH)

(73) Assignee: SWISS KRONO Tec AG, Luzern (CH)

(21) Appl. No.: 16/964,653

(22) PCT Filed: Jan. 24, 2019
(86) PCT No.: PCT/EP2019/051788

§ 371 Date: Jul. 24, 2020

(30) Foreign Application Priority Data
Jan. 26, 2018 (EP) 18153728.3

(51) Int. Cl. B44C 5/04; B05D 5/06; B44C 1/24; B44D 5/00

(52) U.S. Cl. CPC B44C 5/04; B05D 5/06; B05D 2451/00; B44D 5/00; B44C 1/24

(57) ABSTRACT

The invention relates to a method for subsequently altering a decorative surface that is ready for use, including the following steps: providing a material panel with a decorative layer which is ready for use and has a first coloured. decoration and a protective layer with a structured surface. According to the invention, in order to provide a method for subsequently altering a decorative surface that is ready for use, with which the structures can be optically highlighted, without interfering with the mechanical or structural integrity of the decorative surface, a second coloured decoration is applied to the protective layer and unevenly distributed.

### BACKGROUND OF THE INVENTION

The invention relates to a material board and a method for subsequently altering a decorative surface that is ready for use.

Decorative surfaces are, for example, known from the wood material industry. There, wood material boards are equipped with a coloured decoration, to which an appropriate protective layer is then applied in order to protect the coloured decoration. The decorative surface can then additionally be given a surface structure.

The surface structures are, for example, impressed into the protective layer, possibly also right into the coloured decoration layer with the aid of embossed sheets. Different gloss levels can also be produced on the surface at various sections.

A significant disadvantage of the surface structures produced is that the visual effect of the structures depends on the colour of the decorative paper and on the depth of the respective structures on the embossed sheet.

Likewise, the possible ways of altering the visual effect of the surface known from the prior art, such as for example the application of lacquers, stains or the pasting over of surface sections, either lead to restrictions in the mechanical and technical properties or cannot be performed structurewise but are, for the most part, arranged so that they cover all of the surface.

### SUMMARY OF THE INVENTION

The object of the invention is therefore to provide a method for subsequently altering a decorative surface that is ready for use with which the structures can be visually altered without interfering with the mechanical or structural integrity of the decorative surface. Furthermore, the object of the invention is to provide an appropriately produced material board with a subsequently altered decorative surface.

The invention achieves the object by a method having the features disclosed herein and a material board having the features disclosed herein. Advantageous further embodiments of the invention are indicated in the dependent claims. All of the features described, whether in their own right or in any combination, essentially form the subject matter of the invention, independently of the summary thereof in the claims or references back thereto.

According to the invention, in the case of the method for subsequently altering a decorative surface that is ready for use, a material board with a decorative layer which is ready for use and which comprises a first coloured decoration and a protective layer with a structured surface is provided, a second coloured decoration is applied to the protective layer and unevenly distributed.

The method makes it possible to subsequently alter the visual effect of the intrinsically decorative surface of the decorative layer in a particularly simple manner. The structures of the decorative layer are in particular highlighted by the uneven application of the second coloured decoration layer, as a result of which the visual effect of the finished decorative layer can be extensively altered.

Material boards have in particular a base plate which comprises e.g. wood material, in particular a chipboard, fibreboard, cement-bound wood fibre board, wood-plastic composite (WPC), laminate (e.g. HPL, CPL, solid core made of synthetic resin and paper for further coating), mineral fibre, which are in particular bound with a synthetic resin or a mineral binding material, or similar.

In particular, the material boards are used as floor coverings, wall coverings, ceiling coverings or furniture boards.

The decorative layer is part of the material board and is connected e.g. to the base plate. The decorative layer comprises the decorative surface. In the situation in which it is intended to be used, the decorative surface is a visible surface which shows an at least single-coloured first coloured decoration, but in particular shows a multicoloured coloured decoration. Consequently, the decorative layer has a first coloured decoration and a protective layer. The first coloured decoration and the protective layer can be configured with multiple layers. The first coloured decoration can show e.g. a wood decoration, tile decoration, imaginary decoration or similar.

The protective layer can in particular be a layer which is at least as far as possible a transparent, separately configured layer, such as e.g. a lacquer, overlay with synthetic resin such as melamine resin or similar, which is arranged in particular over the entire surface of the coloured decoration and protects the latter against external influences. Especially in the case of surfaces which are not subjected to high mechanical stresses during their later use, the protective layer can also be formed e.g. by the synthetic resin, with which the decorative paper of the coloured decoration has been impregnated; the protective layer can be configured as an integral part of the coloured decoration.

For the structuring of the decorative surface, the protective layer can have a 3D structure, i.e. starting from a central plane, it can have elevations extending from the plane and/or cavities extending into the plane which possibly reach right into the first coloured decoration. The structure can be impressed. Complementing the 3D structure or alternatively, the structuring of the surface can be configured e.g. by a further layer which is applied in sections to the protective layer such as e.g. a transparent lacquer or a transparent synthetic resin, wherein a 3D structure also ultimately results herefrom.

The structuring can, e.g. in the case of a coloured decoration representing a wood, be configured synchronously to the represented wood pores or, in the case of a tile decoration, synchronously to the joints.

The term “ready for use” is understood to mean that the decorative surface of the material board is finally prepared in its surface configuration for its intended purpose, i.e. no further intervention which alters the decorative layer is usually carried out on the decorative surface. The material boards with the decorative surface which is ready for use can, however, e.g. still be dimensionally adapted. Profiling can still be arranged at the side edges as well. Thus, corresponding locking profiles are particularly advantageously provided, which make it possible to lock two material boards to one another without using glue and prevent e.g. a height offset and a gap occurring between two material boards which are locked to one another.

Material boards with a decorative layer which is ready for use are e.g. wood material boards having a pressed and structured laminate surface such as e.g. a high pressure laminate (HPL) or a continuous pressure laminate (CPL), or laminates produced as “direct pressed laminate” (DPL) having wood material boards or a base plate made of another material. Base plates having an already finally lacquered, structured decorative surface made of lacquer, which can be arranged e.g. on a wood material board, can also be configured as material boards with a decorative layer which is ready for use. Consequently e.g. wood material boards such as fibreboards, preferably MDF (medium density fibreboard), HDF (high density fibreboard) or CDF (compact density fibreboard) or chipboards are deployed as the base plates of the material boards.

Material boards made of WPC having a structured definitive surface can equally be considered to be ready for use, wherein the first coloured decoration or parts of the first coloured decoration is/are, for the most part, formed from the primary colour of the WPC material, i.e. of the plastic matrix and the wood particles or respectively paper particles or similar. Pure laminated boards such as HPL, CPL inter alia, which have one or more sheets of a base paper, an appropriate first coloured decoration, a protective layer and a structured surface already, can also be considered to be ready for use. Accordingly, e.g. solid cores made of multiple synthetic resin-impregnated papers pressed to one another, which can be coated with a decorative layer, can likewise be considered to be a base plate for the material board.

Lastly fibre cement boards or glass-fibre reinforced plastic boards, for example, can also be utilised as the base plate for the material board. These can be coated e.g. like wood material boards or solid cores with a laminate surface, with synthetic resin-impregnated papers in the DPL method or with a decorative layer which is ready for use on the basis of a lacquer coating. The decorative layer which is ready for use can also be formed, e.g. similar to WPC boards, at least partially from the material of the fibre cement boards or the glass-fibre reinforced plastic boards themselves.

The term “subsequent altering” is understood to mean that a material board having a decorative surface which is completed for its intended purpose is adapted by a second coloured decoration. The second coloured decoration is consequently also arranged after the protective layer has already cured completely. No wet-on-wet application is carried out.

The second coloured decoration is accordingly formed by means of colour particles applied to the protective layer. The second coloured decoration can, for example, be configured to be single-coloured. However, colour particles having a different colouration can also be arranged including, possibly, in multiple work steps. In particular, the colour of the second coloured decoration is configured to contrast with the first coloured decoration.

The term “application of the second coloured decoration” is understood to mean that the particles configuring the second coloured decoration are applied to the protective layer. This can be carried out by means of known methods and devices for applying solid powdery particles or by methods and devices for applying correspondingly pigmented liquid surface coatings. In particular, the second coloured decoration can consequently be sprayed on, rolled on or spread thereon.

The particles are distributed unevenly in different ways. In the case of solid powdery particles, following the application of e.g. a layer thickness which is uniform as far as possible, the surplus powdery particles can be removed. These are removed unevenly, resulting in an uneven distribution of the particles remaining on the surface.

In the case of surface coatings applied in liquid form, these can likewise either be distributed unevenly following the application or directly during the application of the liquid coating.

Various methods or intermediate steps can be performed in order to apply the second coloured decoration and/or in order to produce the uneven distribution. The powdery colour particles or respectively the liquid surface coating can thus be applied e.g. by being sprayed on, spread, rubbed, brushed in, massaged in, impressed or sprayed (into the structures), as a result of which two work steps, namely the application and the uneven distribution, can e.g. be performed simultaneously.

Of course, method steps such as rubbing, brushing in, massaging in, impressing, spraying in, etc. can also only be performed in order to produce an uneven distribution, i.e. the second coloured decoration is applied, e.g. sprayed on, spread or applied by percolation and then correspondingly rubbed, brushed in, massaged in, impressed, etc.

In the case of a second coloured decoration which contains magnetic or ferromagnetic particles, an uneven distribution can also be performed e.g. by means of an electromagnetic distribution.

The term “uneven” is understood in connection with the invention to mean that visible optical effects are produced, in particular the second coloured decoration has different colour intensities (dark-light) over the surface. This is the result of the fact that the application quantity of the second coloured decoration remaining between individual sections of the surface following the distribution is different. The second coloured decoration can in particular be configured to be single-coloured or at least single-coloured as far as possible. Colour particles for the second coloured decoration can thus, for example, all have the same colour or can be a mixture of colour particles having a similar colour. Thus, the colour intensity, i.e. the brightness level, can in particular be controlled appropriately by the remaining application quantity. Ultimately, this means that following the application and the distribution of the colour particles of the second coloured decoration, the decorative surface has sections with a maximum quantity of colour particles, sections with a minimum quantity of colour particles and sections with a quantity of colour particles which lie between the maximum and minimum quantity. In particular, the second coloured decoration is arranged over the entire structured surface such that, following the distribution, no sections of the structured surface without colour particles are preferably present, wherein this is of course possible as a decorative variant.

According to a further embodiment of the invention, the structured surface has elevations and cavities and the second coloured decoration is arranged in the region of the elevations and/or the cavities.

The structured surface, in particular the protective layer, has a central plane, from which the elevations extend outwardly away from the first coloured decoration or respectively from which the cavities extend inwardly in the direction of the first coloured decoration, possibly right into the first coloured decoration. By arranging the second coloured decoration in sections in the region of the elevations and/or in the region of the cavities, the structures produced as a result are particularly highlighted. The optical impression is altered to the effect that the viewer can perceive the structuring of the surface to a significantly greater extent.

The second coloured decoration can in principle be arranged on the entire surface, that is to say both on the elevations, the cavities and in the region of the central plane. However, the remaining quantity is varied in sections. According to a further embodiment of the invention, a particular improvement of the perception of the structures is achieved in that a larger quantity of the particles producing the second coloured decoration is arranged in the region of the elevations and/or in the region of the cavities than in the central planes located therebetween.

As already indicated, there are various possible ways of producing the second coloured decoration. According to a further embodiment of the invention, it is provided that, in order to produce the second coloured decoration, colour particles in powder form are applied to the structured surface and surplus colour particles are then removed.

The colour particles can, as far as possible, be applied uniformly to the structured surface. This can be performed for example by means of a spraying and/or a spreading device. The uneven distribution is then performed by removing surplus colour particles. To this end, the colour particles can be sucked off or blown off, for example.

According to a further embodiment of the invention, it is however provided that the colour particles are brushed off. The brushing off is in particular carried out by means of a round brush. The brush, whatever the configuration thereof, is in particular moved over the surface at a low pressure such that, especially in the region of cavities, the existing colour particles are only brushed off to a small extent.

In addition, in order to improve the distribution of powdery colour particles in the region of elevations, the colour particles are in particular only brushed off over the face in one direction. As a result, the colour particles are pressed, by means of the brush, onto an edge of an elevation opposed to the direction of movement of the brush, in the region of elevations, or respectively are not brushed off at all or only brushed off to a small extent on the edge of the elevation pointing in the direction of movement of the brush. The distribution quantity of the colour particles in the region of the elevations can consequently be significantly increased compared with the central plane or respectively the sections which do not have any structuring but are executed in a planar manner.

It would in principle be possible for the powdery colour pigments to be fixed on the protective layer, for example, by means of a heat treatment. However, a fixing layer is particularly preferably arranged on the second coloured decoration and, consequently, also above the protective layer. The fixing layer can be configured, for example, as a lacquer layer and can also be applied in multiple layers, for example. The fixing layer is in particular applied particularly thinly, preferably in the range of 0.5 g/m² to 100 g/m², preferably in the range of 5 g/m² to 50 g/m². The fixing layer can also be configured as a protective layer for the second coloured decoration. The fixing layer is preferably configured to be completely transparent.

As an alternative to applying powdery colour particles, according to a further embodiment of the invention, a pigmented liquid surface coating is applied to the structured surface in order to produce the second coloured decoration, i.e. the colour particles forming the colour of the coloured decoration exist as pigments in a liquid and are applied jointly with the latter to the structured surface.

The liquid surface coating can, for example, be configured as a pigmented liquid lacquer. This surface coating can be applied over the entire surface but can also be applied, for example, particularly thinly in sections. In principle, the application can be carried out with the usual application devices. Thus, different quantities of liquid coating agent could be applied in sections, for example, by means of a spraying device. Following the application and, possibly, the ensuing distribution, the liquid surface coating is cured. This can be carried out, for example, by means of UV light or by means of electron beam curing. Of course, a fixing layer or respectively a further protective layer can also be applied to the second coloured decoration which is applied as a pigmented liquid surface coating and cured. This is in particular configured from the same material as the second coloured decoration, e.g. a lacquer, and is preferably configured to be completely transparent.

The pigmented liquid surface coating is also described below as a liquid surface coating containing colour particles.

Both the colour particles configured in the form of powder and the colour particles (pigmented liquid coating agent) present in the liquid coating agent can be applied both to a decorative surface which is ready for use having a protective layer made of synthetic resin and to a protective layer made of lacquer. In order to improve the adhesion, e.g. an adhesion agent, primer or similar can still be applied to the decorative layer which is ready for use prior to the application of the second coloured decoration.

The second coloured decoration layer, in particular a second coloured decoration layer configured as a liquid coating agent, is particularly preferably applied by means of an applicator roller. The roller can be guided in such a way that a greater contact pressure is produced on the roller in the region of elevations, by virtue of which greater contact pressure a larger quantity of the liquid coating agent is also transferred from the applicator roller to the elevation. Accordingly, a small application quantity can be transferred by the roller in the region of the central plane or respectively of cavities. It is also possible, for example, to make the applied coating agent run by adjusting the viscosity of the liquid coating agent, such that a larger quantity of coating agents collects in the region of cavities than, for example, in the region of elevations.

Alternatively or additionally, according to a further embodiment of the invention, the application quantity of both the liquid coating agent containing colour particles and the powdery colour particles is controlled by means of the design of the protective layer on the first coloured decoration.

To this end, according to a further embodiment of the invention, it is provided that the structured surface has sections having high and low roughness and the second coloured decoration is unevenly distributed in such a way that a larger quantity of colour particles (in powder form or in the form of the pigmented liquid coating agent) is arranged at sections having higher roughness than at sections having, by way of contrast, lower roughness, which are smoother by way of contrast. It is consequently possible to control to what extent the respective sections receive the applied colour particles or respectively how well the applied colour particles adhere to the respective sections by means of the roughness of individual sections. It should be noted that the roughness is observed in particular in the region of microstructures. This is understood to mean that e.g. the microporosity of the surface is adapted. Thus, the surface of an elevation, a cavity and/or a central plane can for example have micropores in sections or completely, or can be highly compacted (fewer to no micropores) in sections. Of course, e.g. elevations, cavities and/or central planes adjacent to one another can also be highly compacted or equipped with micropores. Fewer colour particles stick to highly compacted sections than to the less compacted surface sections which have, for example, more micropores by way of contrast.

As an alternative or in addition to the control by means of the roughness of individual sections, the control can also take place via the gloss level of the individual sections. Thus, according to a further embodiment of the invention, it is provided that the structured surface has sections with different gloss levels, wherein the second coloured decoration is applied in a larger quantity at sections having a lower gloss level than at sections which, by way of contrast, have a higher gloss level.

The gloss level of the decorative surfaces or respectively of the individual sections, which are configured for example as lacquer surfaces or synthetic resin surfaces, can be determined in accordance with DIN EN ISO 2813. However, in the case of the embodiment according to the invention, it is not the absolute gloss level of the respective sections that is crucial to the uneven distribution, but the difference in gloss level between two or respectively multiple sections and the associated difference in the application quantity.

The colour particles used for the second coloured decoration are, according to a further embodiment of the invention, particles made of graphite, carbon, ferromagnetic particles, iriodin or kaolin or a mixture of at least two of the aforementioned particles which are used as powdery particles or as particles (pigments) in a liquid surface coating.

The object of the invention is further achieved by a material board (furniture and facing board) comprising a decorative surface which is ready for use with a decorative layer which has a first coloured decoration, a protective layer and a structured surface, wherein an unevenly distributed, second coloured decoration is arranged on the protective layer.

The inventive material board makes possible a particularly simple and extensive transformation of the surface and in particular the emphasizing of the structures, as a result of which the extensive optical transformation can be produced.

The material board can in particular comprise a wood material board configured as a base plate such as a chipboard, fibreboard, OSB board. The respective base plate is equipped with the decorative surface. The decorative surface is formed by means of a decorative layer which comprises at least a first coloured decoration and a protective layer and a structuring of the surface, in particular of the protective layer. The second coloured decoration is applied above or respectively on the protective layer, starting from the first coloured decoration.

In the process the uneven distribution of the second coloured decoration is adapted in particular to the structuring. The structuring in turn can, for example, comprise elevations or cavities. Alternatively or additionally, it is possible to configure the structuring for example over sections of the surface which have a different roughness and/or over sections of the surface which have different gloss levels.

In order to produce the colour of the coloured decoration, the second coloured decoration contains colour particles or respectively consists of colour particles. The second coloured decoration is particularly preferably configured to be single-coloured or at least single-coloured as far as possible, i.e. the particles contained in the second coloured decoration all have the same or respectively have the same colour as far as possible. This makes the application of the second coloured decoration considerably easier and already brings about a significant alteration in the overall view of the decorative surface. Due to the uneven distribution of the second coloured decoration, in the case of those coloured decorations which are single-coloured or at least single-coloured as far as possible, sections having a different colour intensity are created. This means that sections having fewer colour particles appear significantly lighter, e.g. like a transparent veil of colour, compared with sections having a larger quantity of colour particles. In the process, in particular, a dark pigment is used for the second coloured decoration.

The material board is in particular a furniture board and/or a facing board which can be utilised as a wall, ceiling and/or floor covering.

### DETAILED DESCRIPTION

The invention is explained in greater detail below with reference to exemplary embodiments.

### EXAMPLE 1

In order to subsequently alter a decorative surface, a material board with a decorative layer which is ready for use is first provided. The material board has a base plate, here a wood material board which is configured as a fibreboard. An MDF board, HDF board or CDF board is in particular used as the fibreboard. Alternatively, a chipboard, a fibre cement board, a glass-fibre reinforced plastic board or solid core can also be used as the base plate.

A DPL decorative layer is arranged on the base plate. This has been compressed with the base plate under the action of pressure and heat in a press. In addition to various base papers, the DPL decorative layer also has a first coloured decoration which in this case shows a wood decoration. A synthetic resin-impregnated overlay is arranged on the first coloured decoration as a protective layer. During the pressing of the DPL decorative layer with the base plate, a 3D structure has been impressed into the protective layer by means of an embossing device. In addition, glossy pores have been produced on the protective layer, i.e. on the surface of the DPL during the pressing. These are in particular arranged in the region of the elevations of the 3D structure. The decorative surface produced is ready for use.

In order to alter the visual effect, in particular in order to highlight the impressed structures, colour particles, here graphite particles in powder form, are applied to the structured surface of the protective layer. The graphite particles are then partially removed from the surface, in this case brushed off with a round brush. The rotating round brush is guided over the material board in one direction of movement. Different quantities of graphite particles remain on the individual sections of the structured surface. Whilst a particularly large quantity of graphite particles is brushed in in the region of the largest cavities, and consequently remains there, the remaining quantity is significantly lower in less deeply structured regions. Independently thereof, the remaining quantity of colour particles (graphite dust) is higher in the region of the matt sections than in the region of the glossy pores. This creates an uneven distribution of the graphite particles on the protective layer. In order to fix the graphite particles, a particularly thin lacquer layer, which covers the entire decorative surface of the material board and consequently also the graphite particles, is then applied and cured by means of UV light. Alternatively, other powdery pigments can also be applied, for example. A lacquer which is cured by means of electron beam curing could also be applied as a fixing layer.

A material board which is produced in this way can, for example, be separated for further processing. Corresponding locking profiles can then be arranged on the side edges such that panels are created. The corresponding locking profiles can be configured as glueless locking profiles which prevent both a height offset of the panels connected to one another and the formation of a gap between the connected panels. Alternatively, panels can also be separated or respectively produced by arranging the corresponding locking profiles prior to the subsequent processing.

### EXAMPLE 2

A material board having a decorative surface is provided. The material board has a base plate made of wood material, in this case a fibreboard. A first coloured decoration has been applied to the fibreboard. The coloured decoration has been produced in multiple thin layers and shows a wood decoration. A transparent protective layer made of lacquer has been applied to the coloured decoration. Glossy pores have in turn been applied to the transparent protective layer in regions, in which the coloured decoration shows pores of the wood. The glossy pores likewise consist of a lacquer which has a higher gloss level compared with the transparent protective layer, but which—as described—has only been applied to individual sections of the surface. The decorative surface is ready for use.

In order to alter the visual effect of the decorative surface, a dark pigmented lacquer is provided. The lacquer is rolled onto the surface at a particularly low pressure and particularly thinly by means of an applicator roller. Due to the low pressure and the particularly thin method of application, significantly less pigmented lacquer sticks in the region of the glossy pores compared with the sections of the structured surface, to which no glossy pores are applied. The pigmented lacquer layer is then cured, in this case by means of UV light. Alternatively, an electron beam curing can, for example, also be performed to this end.

A material board which is produced in this way having a subsequently altered decorative surface can also be separated as described in Example 1 and can be further processed to form the panel. Alternatively, the separation and the further processing to form the panel can also be carried out prior to altering the visual effect of the decorative surface, such that the subsequent altering of the decorative surface is performed on the individual panels.

Irrespectively of whether the second coloured decoration is applied as powder, plate-shaped pigment or as a liquid surface coating, a material board made of, for example, fibreboard, chipboard, OSB board, laminate board or WPC or respectively a multi-layered board made of a combination of said materials can in principle be used. In addition, the second coloured decoration produced by means of a powder and a fixing layer can of course also be applied to a lacquer surface which is ready for use, or respectively the second coloured decoration which is configured as a liquid coating agent can be applied to a synthetic resin surface which is ready for use.

Although some aspects have been described in connection with or as one method step, it is understood that these aspects also constitute a description of an appropriate block or detail or feature of an appropriate device. Similarly, aspects which have been described in connection with a device also constitute a description of the appropriate method such that a block element or a component of a device is also to be understood to be an appropriate method step or as a feature of a method step.

### EXAMPLE 3

A material board with a decorative layer which is ready for use is provided. The material board comprises a base plate which is configured as an MDF board, CDF board, HDF board, chipboard, solid core, fibre cement board or glass-fibre reinforced plastic board. The base plate is coated with a decorative layer which is ready for use. The decorative layer can comprise a laminated surface, in particular a CPL or HPL or a lacquer coating. In addition, the decorative layer which is ready for use has a structured surface with a 3D structure. The decorative layer which is ready for use can also be applied in accordance with Example 1 using the DPL method.

A second coloured decoration is applied to the decorative layer which is ready for use. To this end, colour particles in powder form are sprayed onto, percolated onto, or e.g. applied by means of an applicator roller to, the structured surface of the decorative layer which is ready for use. The colour particles are then massaged into the structures of the surface by means of an introducing device such as e.g. a cloth or a sponge. Alternatively, the particles can also be applied directly to the introducing device and can be transferred to the surface during massaging in. Alternatively or additionally, the applied, surplus particles of the second coloured decoration can e.g. also be partially brushed off, sucked off or blown off so that an uneven distribution is created.

Irrespective of the method of application and method of distribution, a transparent fixing layer is applied following the uneven distribution. The fixing layer can be configured e.g. as a lacquer layer.

### EXAMPLE 4

Starting from a material board which is provided according to Example 1, 2 or 3, a pigmented liquid surface coating is applied as a second coloured decoration to the structured surface of the decorative layer which is ready for use. The application is carried out by means of a spraying device, but it can alternatively also be carried out e.g. by means of an applicator roller. An intermediate processing of the second coloured decoration is then carried out, during which the applied liquid surface coating is distributed by means of an introducing device. The liquid surface coating can thus be massaged into the structures in accordance with Example 3. Surplus material is thereby removed. The unevenly distributed pigmented liquid surface coating (second coloured decoration) is then dried and cured, e.g. by means of UV light. In order to ensure that the second coloured decoration is particularly protected, a protective layer, e.g. a lacquer layer containing corundum, can be applied to the second coloured decoration and cured.

The indicated materials of the base plate and the materials of the decorative layer which is ready for use can in principle be freely combined. Thus, all of the indicated base plates (fibreboard, MDF board, HDF board, CDF board, chipboard, solid core, fibre cement board, glass-fibre reinforced plastic board and WPC board) can ultimately be coated with any of the indicated decorative layers (HPL, CPL, DPL, lacquer coating, etc.) and can form a material board. All of the indicated decorative layers which are ready for use can also be coated both with colour particles in powder form and with a pigmented surface coating in order to respectively configure a second coloured decoration.

1. A method for subsequently altering a decorative surface that is ready for use, comprising the following steps:
providing a material board with a decorative layer which is ready for use and comprises a first coloured decoration and a protective layer with a structured surface,
wherein
a second coloured decoration is applied to the protective layer and unevenly distributed.

2. The method according to claim 1, wherein the structured surface has elevations and cavities and the second coloured decoration is arranged in the region of the elevations and/or the cavities.

3. The method according to claim 1, wherein a larger quantity of the particles producing the second coloured decoration is arranged in the region of the elevations and/or in the region of the cavities compared to a central plane.

4. The method according to claim 1, wherein, for the second coloured decoration, colour particles in powder form are applied to the structured surface and surplus colour particles are then removed.

5. The method according to claim 1, wherein the colour particles are brushed off.

6. The method according to claim 1, wherein the colour particles are brushed off in one direction.

7. The method according to claim 1, wherein a fixing layer is arranged on the powdery colour particles.

8. The method according to claim 1, wherein a pigmented liquid surface coating is applied to the structured surface for the second coloured decoration.

9. The method according to claim 1, wherein the pigmented lacquer is applied by means of an applicator roller.

10. The method according to claim 1, wherein the structured surface comprises sections having high and low roughness and the second coloured decoration is unevenly distributed in such a way that a larger quantity of colour pigments is arranged at sections having higher roughness than at sections having, by way of contrast, lower roughness.

11. The method according to claim 1, wherein the structured surface has sections with different gloss levels, wherein the second coloured decoration is applied in a larger quantity at sections having a lower gloss level than at sections which have, by way of contrast, a higher gloss level.

12. The method according to claim 1, wherein particles made of graphite or carbon, ferromagnetic particles, iriodin or kaolin or mixtures of two or more of the aforementioned particles are used as powdery particles or as particles in a liquid surface coating.

13. A material board comprising a panel which is ready for use, having
a decorative layer which has a first coloured decoration and a protective layer with a structured surface,
an unevenly distributed, second coloured decoration is arranged on the protective layer.
